(19) United States
(12) Patent Application Publication
(10) Pub. No.: US 2019/0268721 A1
(43) Pub. Date: Aug. 29, 2019

(54) PRODUCING INFORMATION RELATING TO LOCATIONS AND MOBILITY OF DEVICES

(71) Applicant: HEWLETT PACKARD ENTERPRISE DEVELOPMENT LP, Houston, TX (US)

(72) Inventors: Jose Tellado, Santa Clara, CA (US); Bernd Bandemer, Santa Clara, CA (US); Alexander Mendez, Santa Clara, CA (US)

(21) Appl. No.: 15/904,492

(22) Filed: Feb. 26, 2018

(51) Int. Cl. H04W 4/02; G06N 99/00

(52) U.S. Cl. CPC H04W 4/027; G06N 99/005

(57) ABSTRACT

In some examples, a system provides a machine learning model trained based on historical data including network-observed parameters for devices associated with a network. The system inputs values of the network-observed parameters for a first device into the machine learning model, the input values being from a plurality of devices in the network. The machine learning model produces information relating to a location or mobility of the first device.

### BACKGROUND

Wireless electronic devices are able to move around to different locations in a network. The network includes access nodes at multiple locations to which wireless electronic devices are able to establish wireless connectivity. Once a wireless electronic device establishes a wireless connection with an access node, the wireless electronic device is able to perform communications with another endpoint device through the network.

### BRIEF DESCRIPTION OF THE DRAWINGS

Some implementations of the present disclosure are described with respect to the following figures.

FIG. 1 is a block diagram of network arrangement and a location analytics engine, according to some examples.

FIGS. 2 and 3 are flow diagrams of location analytics processes according to various examples.

FIG. 4 is a block diagram of a storage medium storing machine-readable instructions, according to further examples.

FIG. 5 is a block diagram of a system according to additional examples.

FIG. 6 is a flow diagram of a process according to alternative examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Different types of wireless networks can include different types of access nodes to which wireless electronic devices are able to establish wireless connectivity. In a wireless local area network (WLAN), such as a Wi-Fi network that operates according to the Institute of Electrical and Electronics Engineers (IEEE) 802.11 standards, access nodes include access points (APs). In cellular networks, access nodes include base stations that provide respective coverage areas in cells. An example cellular network can operate according to the Long-Term Evolution (LTE) standards as provided by the Third Generation Partnership Project (3GPP). The LTE standards are also referred to as the Evolved Universal Terrestrial Radio Access (E-UTRA) standards. In other examples, cellular networks can operate according to other protocols, such as a Global System for Mobile (GSM) protocol, an Enhanced Data rates for GSM Evolution (EDGE) protocol, a Universal Terrestrial Radio Access Network (UTRAN) protocol, a Code Division Multiple Access (CDMA) 2000 protocol, and so forth. In further examples, cellular networks can be fifth generation (5G) or beyond cellular networks.

Other types of access nodes can be used in other types of networks. Generally, an access node is a network device that a wireless electronic device can establish a wireless connection with to allow the wireless electronic device to communicate with another endpoint device over a network to which the access node is connected.

Examples of wireless electronic devices include any or a combination of: a notebook computer, a tablet computer, a smartphone, a game appliance, a wearable device (e.g., a smart watch, smart eyeglasses, a head-mounted device, etc.), a vehicle, and so forth. Wireless electronic devices that are able to establish network connectivity with access nodes are also referred to as client devices.

A network operator or other entity may desire to gain insight into locations or mobility of wireless electronic devices that operate in a network. In some examples, determining locations or mobility of wireless electronic devices may be based on information acquired by dedicated hardware or dedicated signaling, which can be complex and costly to implement. For example, including hardware in wireless electronic devices to enable location or mobility tracking of the wireless electronic devices can add to the cost of the wireless electronic devices. Also, using dedicated signaling to perform location or mobility tracking of the wireless electronic devices adds to the operational complexity of both the wireless electronic devices and access nodes in the network.

In accordance with some implementations of the present disclosure, techniques or mechanisms use a machine learning model trained based on historical data including network-observed parameters for devices (including client devices and/or access nodes) associated with a network to produce, by the machine learning model, information relating to a location or mobility of a client device.

The location of a client device can be expressed as an absolute coordinate (e.g., latitude and longitude), a general physical location (e.g., in a specific office or cubicle, in a specific room, in a specific building, in a specific store, at a specific landmark, etc.), a relative location (e.g., a distance to an access node or another entity having a known position), or any other location information that provides an indication of where the client device is located. A location of a client device may include the orientation of the client device relative to a coordinate system, for example facing north, or facing down, or in a horizontal or vertical direction. For example, the location may be expressed as a vector indicating the orientation of a predetermined side of the client device relative to a coordinate system.

The mobility of a client device can include mobility information that indicates movement of the client device. For example, the mobility information can include a direction of travel of the client device, a speed of the client device, an acceleration of the client device, an indication of whether the client device is moving or stationary, and so forth.

A network-observed parameter can refer to a parameter that can be measured, obtained, or inferred by a device (a client device and/or an access node). Examples of network-observed parameters include any or some combination of the following:

1) A parameter based on measurement of a wireless signal, such as a received signal strength indicator (RSSI) (that provides a measurement of the power present in a received wireless signal), a signal-to-noise ratio (SNR) (that provides an indication of a ratio of a magnitude (e.g., power) of a useful signal (that carries data or other information) to a magnitude (e.g., power) of noise. In other examples, other parameters based on measurements of wireless signals can be used. Further, in some cases, multiple parameters can be used, which can be included in a vector of parameters. The measurement of the wireless signal can be of a wireless signal transmitted by a client device to an access node. In other cases, the measurement of the wireless signal can be of a wireless signal transmitted by an access node to a client device or from a first access node to a second access node. More generally, such parameters represent characteristics of wireless communication between devices.

2) A property of an access node, such as an identity (e.g., name, network address, etc.) of an access node to which a client device is connected. Other example properties of an access node include a node model of a client device (e.g., an access node made by manufacturer X, an access node made by manufacturer Y, a specific model number of an access node, etc.), a capability of an access node, a setting of an access node (e.g., number of antennas, a gain of a receiver of the access node, etc.), a location of an access node, and so forth.

3) A timestamp for an event detected in the network.

4) A property of a client device. Example properties include a device type of a client device (e.g., a tablet computer, a smartphone, etc.), a device model of a client device (e.g., a client device made by manufacturer X, a client device made by manufacturer Y, a specific model number of a client device, etc.), or a location of a client device.

5) A parameter representing a pathloss between access nodes. A pathloss refers to a reduction in power of a wireless signal as the wireless signal propagates between access nodes. The pathloss can be used to understand how lossy an environment is between access nodes.

6) A parameter representing a time of signal propagation or physical distance between devices, such as between a client device and an access node. The distance can be obtained from a time of flight (ToF), for example, which indicates an amount of time (and thus distance) for a signal to propagate (one-way or round-trip) between the devices

7) A parameter representing an arrangement of access nodes in the network, such as specific locations of the access nodes, a density of the access nodes, and so forth.

8) A parameter representing an operational aspect of a client device, such as whether or not the client device is active or idle (e.g., actively transferring a large amount of data or actively running a business critical application.

Although specific examples of parameters are listed, it is noted that in other examples, additional or alternative parameters can also be used for performing location analytics.

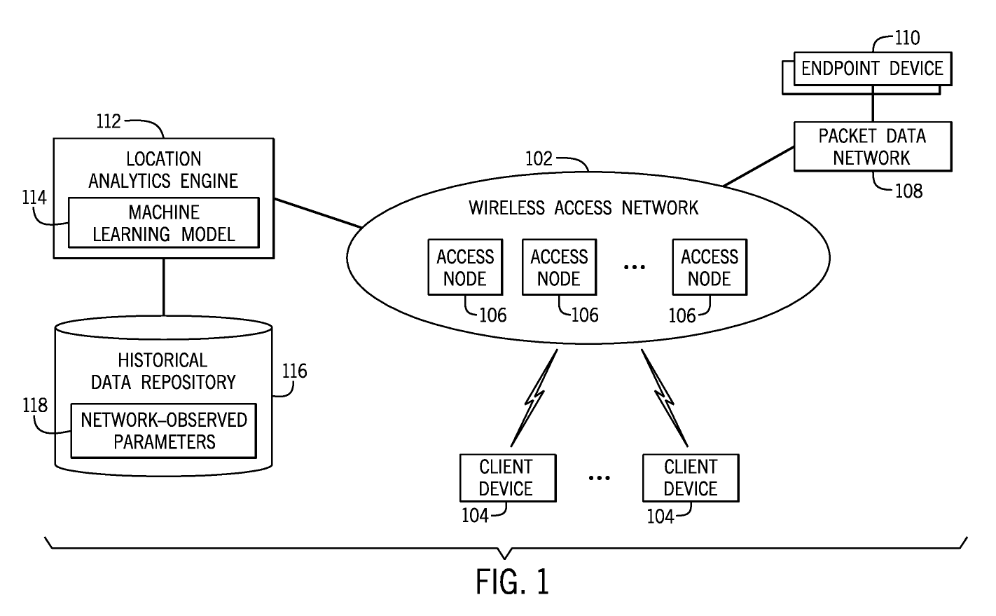

FIG. 1 is a block diagram of an example arrangement that includes a wireless access network 102 to which various client devices 104 are able to connect. The wireless access network 102 can be a WLAN that operates according to the IEEE 802.11 standards. Alternatively, the wireless access network 102 can be a cellular network or other type of wireless network. The wireless access network 102 includes various access nodes 106. Each access node 106 has a respective coverage area. If a client device 104 is within the coverage area of a particular access node 106 (or a group of access nodes 106), then the client device 104 is able to establish a wireless connection with the particular access node 106 (or interact with a plurality of access nodes 106).

Once a client device 104 establishes a wireless connection with an access node 106, the client device 104 can perform communications through the wireless access network 102 with a packet data network 108, or other type of network. For example, the packet data network 108 can include a public network such as the Internet. Alternatively, the public packet network 108 can include a local area network (LAN) or a wide area network (WAN) of a particular enterprise, such as a company, an educational organization, a government agency, or an individual.

Endpoint devices 110 can be connected to the packet data network 108. The endpoint devices 110 can include any or some combination of the following: user devices, server computers, storage systems, and so forth.

In accordance with some implementations of the present disclosure, a location analytics engine 112 is able to use a machine learning model 114 to produce information relating to a location or mobility of a client device (or multiple client devices) 104 based on network-observed parameters.

An “engine” can refer to a hardware processing circuit, which includes any or some combination of the following: a microprocessor, a core of a multi-core microprocessor, a microcontroller, a programmable integrated circuit device, a programmable gate array, or any other type of hardware processing circuit. Alternatively, an “engine” can refer to a combination of a hardware processing circuit and machine-readable instructions executable on the hardware processing circuit.

The machine learning model 114 can be trained using historical data in a historical data repository 116. The data repository 116 can be implemented with a storage device or multiple storage devices. The historical data includes values of network-observed parameters 118 for devices (client devices 104 and/or access nodes 106) that have been collected over time during operation of the wireless access network 102.

To determine the location or mobility of a given client device 104, the location analytics engine 112 can receive input information from which network-observed parameters can be derived. The input information can be from an access node 106 (or multiple access nodes 106) and/or from a client device 104 (or multiple client devices). For example, an access node can make a measurement of a wireless signal to derive an RSSI, SNR, or other parameter, as examples. The access node 106 can also provide a timestamp for an event detected in the wireless access network 102. An event may relate to a connection event associated with a client device 104 requesting establishment of a wireless connection with the access node 106, a data transfer event relating to the transmission of data, a connection termination event relating to termination of a wireless connection between a client device 104 and the access node 106, and so forth.

Additionally, the access node 106 may provide an identifier of the access node 106, pathloss information regarding a pathloss between access nodes, ToF measurements, information pertaining to a client device 104, and so forth.

In further examples, a client device 104 can provide input information from which network-observed parameters can be derived. For example, the client device 104 can provide location information indicating a location of the client device 104. The location information can be based on Global Positioning System (GPS) data acquired by the client device 104 or based on other types of data. As another example, the client device 104 can measure a characteristic of a wireless signal received by the client device 104, and can provide the measurement information.

Other information, for example, a conference room location and a list of scheduled attendees and client devices associated with the attendees can be used for training.

Using the network-observed parameters computed based on the input information received by the location analytics engine 112, the machine learning model 114 is able to produce information relating to a location or mobility of the particular client device 104 (or multiple clients 104 or statistics associated with groups of client devices 104—e.g., average number of client devices per location per time interval or maximum number of client devices over time).

The machine learning model 114 can be implemented using any of various different types of machine learning models. Some example machine learning models are discussed below.

In some examples, the machine learning model 114 can include a regression model, such as a linear regression model, a network-observed fingerprint vectors model, a neural networks model, a random forest regression model, and so forth.

A regression model generates a mapping between a set of input network-observed parameters and a location or mobility of a client device. Regression employs a learning algorithm that best fits a client device location or mobility between the input features (network-observed parameters) by minimizing a metric (e.g., error of an estimated location or mobility relative to a known location or mobility of the client device).

The training of a regression model may include supervised training in which the regression model approximately is trained with training data (including records containing respective values of network-observed parameters and corresponding known locations/mobility of client devices).

In other examples, the machine learning model 114 can include a classification machine learning model, such as a K-nearest-neighbors model, a K-means model, a support vector machine, and so forth.

A classification machine learning model assigns a partition label of the available location or mobility states (e.g., {indoor, outdoor}, {building_1, building_2, . . . building_N}) to a set of input features (network-observed parameters). The assignment of partition labels provides a set of labels for individual devices and ensembles of devices in which the devices assigned a particular label are more similar to each other than to devices assigned other labels.

The assignment of partition labels may be implemented via an unsupervised training technique, where the partition labels are assigned via observed differences in their SNR vectors. Then, in a possible second stage, the assigned partition labels are correlated with known partition labels.

Additionally or alternatively, the assignment of partition labels may be implemented using supervised training that assigns labels via client-observed labels (e.g., timestamped indoor/outdoor labels, moving/stationary labels) that are used to train the classification machine learning model to predict a location or mobility value given input network-observed parameters.

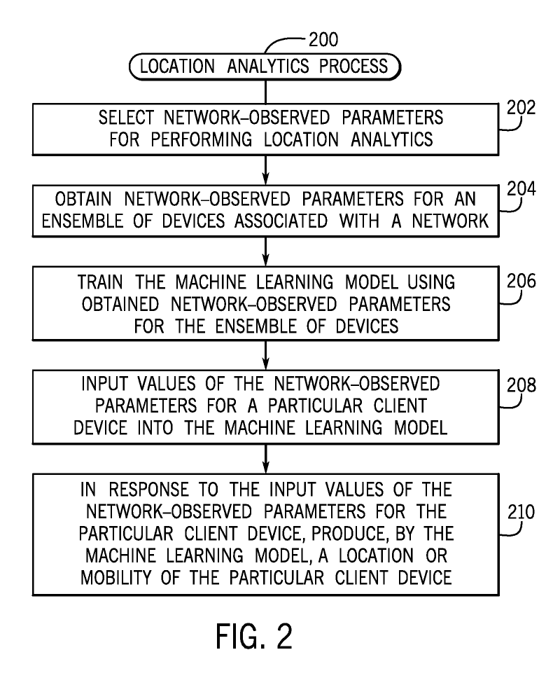

FIG. 2 is a flow diagram of a location analytics process 200 performed by the location analytics engine 112 according to some examples. The location analytics engine 112 selects (at 202) network-observed parameters for performing location analytics. The selected network-observed parameters can include any or some combination of the various parameters listed above. The selection of network-observed parameters for performing location analytics can be based on user input (such as from an administrator), or based on machine learning that has determined which network-observed parameters are optimal for determining a location or mobility of a client device.

The location analytics engine 112 obtains (at 204) network-observed parameters for an ensemble of devices associated with a network, such as the wireless access network 102, where the network observed parameters for the devices have values that vary over time. The “ensemble” of devices can refer to any group of devices that were tracked over time. Network-observed parameters for devices can refer to network-observed parameters for actual devices, or network-observed parameters for types of devices or device models. For example, client devices 104 can send probe requests, such as probe requests according to IEEE 802.11, to discover wireless access networks. The probe requests can be issued over multiple channels and bands, and can be sent by client devices 104 when looking for an alternative access node to roam. Network-observed parameters can be based on information in the probe requests, or based on information from other messages, either from client device(s) 104 or from access node(s) 106.

The obtained network-observed parameters can be obtained from the historical data repository 116 or from monitoring of communications in the wireless access network 102. The obtained network-observed parameters for the ensemble of devices are used to train (at 206) the machine learning model 114 used by the location analytics engine 112. The training of the machine learning model 114 can include supervised training, such as with training data that has been labeled with ground truth information regarding locations or mobility of devices. Alternatively, the training of the machine learning model 114 can be based on unsupervised training. Unsupervised training can refer to training that is based on data obtained during operation of the wireless access network 102. Location and/or mobility predictions made using the machine learning model 114 may be determined to either be accurate or inaccurate (such as based on feedback from users or from other entities). Such feedback can be used to modify the machine learning model 114 to either (1) reinforce that the machine learning model 114 has accurately predicted a location or mobility of a client device (or client devices), or (2) indicate that the machine learning model 114 has incorrectly made a prediction of a location or mobility of client device(s), which can cause the machine learning model 114 to modify its algorithm that maps or otherwise transforms values of selected network-observed parameters to locations and mobility information.

The location analytics engine 112 inputs (at 208) values of the network-observed parameters for a particular client device into the machine learning model 114. The input values of the network-observed parameters can be from multiple devices, such as from multiple access nodes that are within range of the particular client device. By using input values of the network-observed parameters from multiple devices rather than from just one device, more accurate location analytics can be applied by the machine learning model 114. For example, a minimum number of access nodes 106 may be used before determining a location or mobility of a client device. As a further example, an accuracy of an estimated location can be weighted based on the number of access nodes 106 providing network-observed parameters. If a large number of access nodes 106 provide network-observed parameters, a subset (for example based on quality of a parameter) of the access node data may be selected.

In response to the input values of the network-observed parameters for the particular client device 104, the machine learning model 114 produces (at 110) a location or mobility of the particular client device.

FIG. 3 is a flow diagram of a location analytics process 300 performed by the location analytics engine 112 according to alternative examples. In addition to the tasks of FIG. 2, the location analytics process 300 shown in FIG. 3 includes additional tasks.

Following obtaining the network-based parameters (at 204), the location analytics engine 112 computes (at 302) an environment parameter for an access node (or multiple access nodes) in a neighborhood of the particular client device. The environment parameter represents an environment of an access node. For example, the environment parameter can indicate, such as with respective different values of the environment parameter, whether the access node is an indoor access node or an outdoor access node. Also, the environment parameter can indicate that the access node is deployed in a dormitory, in a school, in a retail outlet, in a work environment, and so forth. Access nodes used in different environments can exhibit different signal propagation characteristics. An access node used in an outdoor environment may have less obstacles to signal propagation or different obstacles (e.g., trees, buildings) to signal propagation than an access node used in an indoor environment (where walls and furniture, for example, may interfere with signal propagation).

The computing of the environment parameter (at 302) can be based on various input information, such as any or some combination of the following: a pathloss between access nodes, a pathloss between access nodes and client devices, a density of access nodes, and so forth. Different pathloss characteristics can indicate whether or not an access node is indoor or outdoor, for example. Also, a higher density of access nodes can indicate that such access nodes are deployed indoor.

Knowing the physical environment (e.g., indoor versus outdoor, path loss exponent, access node density, etc.) of an access node with which a client device is connected (or probing, scanning, etc.) can assist in estimating the location or mobility of the client device. For example, a characteristic of a wireless signal (e.g., the RSSI) received at an access node form the client device can be a function of signal attenuation and can be dependent on presence of obstructions (and materials of such obstructions). Signal attenuation caused by a wall or window may be different from signal attenuation in an outdoor environment. Estimating the environmental parameter can assist in performing more accurate location analytics, since the machine learning model 114 can take into account the different behaviors of indoor versus outdoor access nodes, or more generally access nodes of different deployment environments. Different signal propagation effects of signals for access nodes can be used as part of training the machine learning model 114 for estimating location and mobility for a client device.

In some examples, another environment parameter that can be computed is an environment parameter that indicates a uniformity of locations of access nodes. Uniformity of access node locations can refer to how regular placement of access nodes is. For example, a grid of access nodes with regular spacing between the access nodes is an example of an arrangement of access nodes where the placement is uniform. In other examples, access nodes can be placed with differing spacing between the access nodes, which results in a non-uniform placement of the access nodes. Non-uniformity of AP locations may also result in errors in location analytics and is another environmental feature that may be used in training the machine learning model 114.

Tasks 304, 306, and 308 below are performed to estimate mobility patterns of client devices, such as a given group of client devices. The location analytics engine 112 estimates (at 304) a location and/or mobility of each client device of the given group of client devices at different times (e.g., every 30 seconds or other time interval). The devices of the given group of client devices can be identified via network-observed parameters associated with client devices. For example, the given group of client devices may be identified by clustering client devices that have similar signal quality measurements (e.g., vectors of pathloss, SNR, etc.) to identify the given group of client devices that have the same connectivity pattern (e.g., devices in the same room, outdoor devices, etc.).

Alternatively, the client devices of the given group of client devices can be identified based on location related parameters, including the environment parameter, such as to identify outdoor devices, indoor devices localized to a single room or building, and so forth. In this way, client devices that are generally in the same vicinity based on the location related parameters can be identified as being part of the given group of client devices.

For the given group of client devices, the location analytics engine 112 generates (at 306) location traces based on estimated location and/or mobility over time, as estimated (at 304). The location traces of the client devices in the given group of client devices form a mobility pattern of the client devices in the given group of client devices. A location trace of a client device can refer to information indicating locations of the client device at different time points. The mobility pattern can indicate, for example, that the client devices are generally moving in a particular direction of travel at a certain speed, that the client devices have stayed stationary in a general area for a certain amount of time, and so forth.

In some examples, the location analytics engine 112 can impose (at 308) constraints on the location traces generated (at 306). The constraint specifies a condition or restriction on movement of a device. For example, constraints can specify a maximum speed of client devices, a maximum change of location or speed within a space (such as a building), not crossing through physical structures (such as walls), traversing multistory building floors in order, and so forth. The imposed constraints can ensure or increase the likelihood that the estimated mobility pattern of client devices provides an accurate representation of the client devices' movement.

Determining mobility patterns of client devices can assist in performing future location or mobility computations for the same client devices or similar client devices (such as those client devices in the same room). For example, the mobility patterns of client devices can be an input feature to the machine learning model 114 to train the machine learning model 114.

The mobility pattern of client devices can be useful in planning a deployment of access nodes. For client devices that are relatively stationary, it may be desirable for the access nodes providing connectivity to such client devices to have a larger amount of network bandwidth capacity and relatively good signal strength coverage, since it is likely that such client devices may be involved in high bandwidth data communications (e.g., video streaming, voice calls, etc.). For client devices that are moving relatively quickly, high network bandwidth capacity or good signal strength coverage may not be as important since the client devices would be moving quickly from access node to access node.

Network configuration optimization can be applied to improve connectivity or performance or user experience relating to client devices. For example, the network configuration optimization can be applied for events of client devices that are indoor or indoor and stationary.

In addition, the mobility pattern of client devices can be used to identify areas of suboptimal coverage or capacity provided by access nodes. For example, if there are a large number of stationary client devices in a specific area, then it may be desirable to add network equipment to the specific area to increase capacity. The mobility pattern of client devices can be used to provide recommendations for the placement of additional access nodes to improve performance of client devices. Alternatively, the mobility pattern of client devices can be used to cause repositioning of existing access nodes.

The mobility pattern of client devices can also be used to determine whether a client device (or multiple client devices) is (are) inside or outside a physical or virtual area of interest, such as a conference room, a lobby, a geofence area, and so forth. For example, if indoor connectivity or coverage is mandatory but connectivity to client devices outdoors is optional, then the determination that the client device is inside or outside the area of interest can be used in determining whether or not to provide connectivity to the client device.

Tasks 206, 208, and 210 are then performed, similar to the corresponding tasks of FIG. 2. However, in the location analytics process 300 of FIG. 3, the training (at 206) of the machine-learning model 114 can further be based on the environment parameter computed (at 302). Also, in the location analytics process 300, values of environment parameters of multiple access nodes can further be input (at 208) to the machine learning model 114. Moreover, the location analytics process 300 produces (at 210) a location or mobility of the particular client device based on the network-observed parameter and the values of the environment parameter input into the machine learning model 114.

In the location analytics process 300, the location analytics engine 112 can further predict (at 310) the location or mobility of the particular client device at a future time point, based on past values of the input network-observed parameters, and possibly the environment parameter.

In the location analytics process 300, the location analytics engine 112 can further perform after-the-fact analysis to refine (at 312) the estimated location or mobility (as estimated at 210) of the particular client device based on past and subsequently received values of the input network-observed parameters, and possibly the environment parameter.

In some examples, the machine learning model 114 can be for multiple different types of client devices. Alternatively, the machine learning model 114 can be produced for just a single type of client device, or for a subset of types of client devices. Producing a machine learning model for a particular type or subset of types of client devices can tailor the machine learning model to more accurately predict locations and mobility for client devices of the particular type or subset of types. For example, different types of client devices can have different signal transmission powers. Moreover, different types of client devices can use different probing strategies (e.g., when to probe and how often to probe) when sending probe requests to discover access nodes.

Different types of client devices can employ different roaming strategies when transitioning between different access nodes.

Different device types of client devices can also be based on the specific applications executing on the client devices. Different applications can use different probing and roaming strategies, for example.

Also, mobility patterns can depend on the types of client devices. For example, a smartphone, a tablet computer, and a game console can have different expected mobility patterns.

Thus, when producing an estimate of a location or mobility of a client device, the machine learning model 114 can take into account the type of the client device.

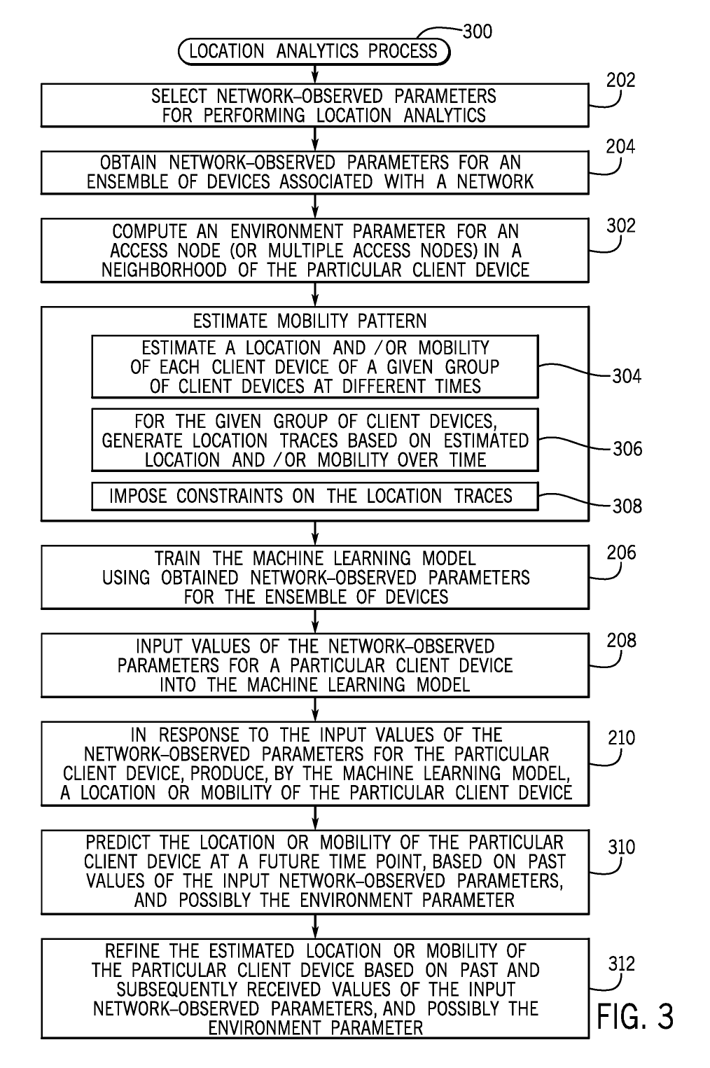

FIG. 4 is a block diagram of a non-transitory machine-readable or computer-readable storage medium 400 that stores machine-readable instructions that upon execution cause a system to perform various tasks. The machine-readable instructions include machine learning model providing instructions 402 that provide a machine learning model trained based on historical data including network-observed parameters for devices associated with a network. The machine-readable instructions further include network-observed parameters inputting instructions 404 to input values of the network-observed parameters for a first device into the machine learning model. The input values are from a plurality of devices (e.g., access nodes) in the network. The machine-readable instructions further include location/mobility information producing instructions 406 to produce, by the machine learning model, information relating to a location or mobility of the first device.

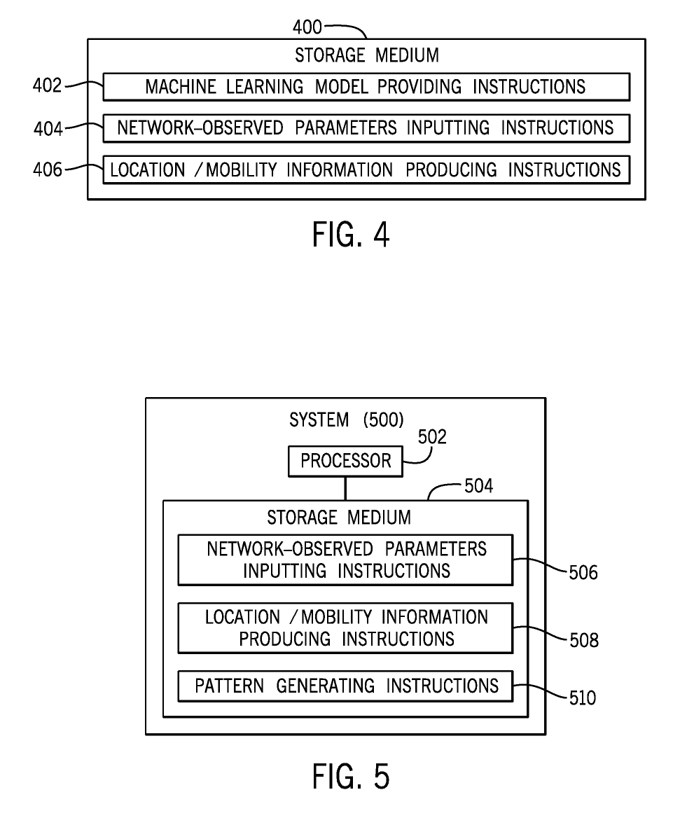

FIG. 5 is a block diagram of a system 500 including a processor 502 (or multiple processors). The system 500 can be implemented as a computer or multiple computers. The system 500 further includes a non-transitory storage medium 504 storing machine-readable instructions executable on the processor 502 to perform various tasks. A processor can include a microprocessor, a core of a multi-core microprocessor, a microcontroller, a programmable integrated circuit, a programmable gate array, or another hardware processing circuit. Machine-readable instructions executable on a processor can refer to the instructions executable on a single processor or the instructions executable on multiple processors.

The machine-readable instructions include network-observed parameters inputting instructions 506 to input values of network-observed parameters for a plurality of devices into a machine learning model. The machine-readable instructions further include location/mobility information producing instructions 508 to produce, by the machine learning model, information relating to respective locations or mobility including directions of travel of the plurality of devices. The machine-readable instructions further include pattern generating instructions 510 to generate a pattern of movement of the plurality of devices over time.

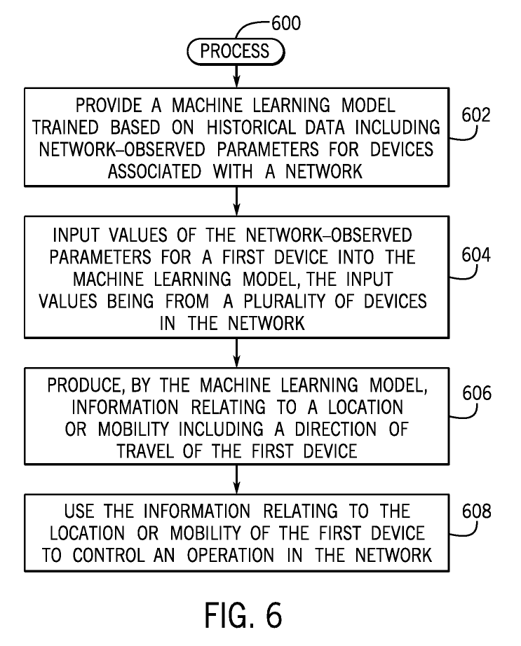

FIG. 6 is a flow diagram of a process 600 performed by a system comprising a processor. The process 600 includes providing (at 602) a machine learning model trained based on historical data including network-observed parameters for devices associated with a network. The process 600 further includes inputting (604) values of the network-observed parameters for a first device into the machine learning model, the input values being from a plurality of devices in the network. The process also includes producing (at 606), by the machine learning model, information relating to a location or mobility including a direction of travel of the first device. The process 600 further includes using (at 608) the information relating to the location or mobility of the first device to control an operation in the network. For example, configurations of access nodes can be changed based on the location or mobility of the first device (and other devices), such as to increase a capacity of an access node, reduce a capacity of an access node for power saving, and so forth.

The storage medium 400 (FIG. 4) or 504 (FIG. 5) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site (e.g., a cloud) from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A non-transitory machine-readable storage medium storing instructions that upon execution cause a system to:
provide a machine learning model trained based on historical data including network-observed parameters for devices associated with a network;
input first values of the network-observed parameters for a first device into the machine learning model, the first values being from a plurality of devices in the network; and
produce, by the machine learning model, information relating to a location and mobility of the first device that comprises a direction of travel of the first device and a speed of the first device.

2. The non-transitory machine-readable storage medium of claim 1, wherein the devices comprise wireless electronic devices and access nodes in the network.

3. The non-transitory machine-readable storage medium of claim 1, wherein the network-observed parameters comprise any or a combination of a parameter indicating a characteristic of wireless communication between devices, a property of an access node in the network, a timestamp of an event in the network, a property of a wireless electronic device, a pathloss between devices in the network, information of an arrangement of access nodes in the network, a parameter indicating a time distance or physical distance between devices, and a parameter representing an operational aspect of a wireless electronic device.

4. The non-transitory machine-readable storage medium of claim 1, wherein the instructions upon execution cause the system to:
determine an environment parameter representing a deployment environment of an access node in the network in a vicinity of the first device,
wherein the machine learning model produces the information relating to the location or mobility of the first device further based on the environment parameter.

5. The non-transitory machine-readable storage medium of claim 4, wherein the deployment environment comprises a physical environment in which the access node is deployed.

6. The non-transitory machine-readable storage medium of claim 4, wherein the instructions upon execution cause the system to further:
determine another environment parameter that represents uniformity of access nodes in the network.

7. The non-transitory machine-readable storage medium of claim 1, wherein the instructions upon execution cause the system to:
input second values of the network-observed parameters for a plurality of devices into the machine learning model;
produce, by the machine learning model, information relating to respective locations or mobility of the plurality of devices; and
generate a pattern of movement of the plurality of devices over time.

8. The non-transitory machine-readable storage medium of claim 7, wherein the instructions upon execution cause the system to:
impose a constraint on the pattern of movement of the plurality of devices, the constraint specifying a condition or restriction on movement of a device and comprises a maximum speed of the device.

9. The non-transitory machine-readable storage medium of claim 1, wherein the instructions upon execution cause the system to:
determine a pattern of movement of a plurality of devices associated with the network based on the historical data; and
train the machine learning model based on the determined pattern of movement of the plurality of devices.

10. The non-transitory machine-readable storage medium of claim 1, wherein the information relating to the location or mobility of the first device comprises a predicted location or mobility of the first device at a future time point.

11. The non-transitory machine-readable storage medium of claim 1, wherein the instructions upon execution cause the system to:
refine the information relating to the location or mobility of the first device based on subsequently received first values of the network-observed parameters.

12. The non-transitory machine-readable storage medium of claim 1, wherein the machine learning model produces the information relating to the location or mobility of the first device further based on a device type of the first device.

13. The non-transitory machine-readable storage medium of claim 1, wherein the instructions upon execution cause the system to:
determine, based on the information relating to the location of the first device, whether the first device is within or outside a specified physical area.

14. The non-transitory machine-readable storage medium of claim 1, wherein the instructions upon execution cause the system to:
input second values of the network-observed parameters for a plurality of devices into the machine learning model;
produce, by the machine learning model, information relating to respective locations or mobility of the plurality of devices; and
provide information, based on the information relating to the location or mobility of the plurality of devices, regarding a deployment of access nodes in the network to improve network performance of wireless electronic devices.

15. The non-transitory machine-readable storage medium of claim 1, wherein the machine learning model produces the information relating to the location or mobility of the first device further based on a level of activity of the first device.

16. A system comprising:
a processor; and
a non-transitory storage medium storing instructions executable on the processor to:
input values of network-observed parameters for a plurality of devices into a machine learning model;
produce, by the machine learning model, information relating to respective locations and mobility including directions of travel of the plurality of devices and speeds of the plurality of devices; and
generate a pattern of movement of the plurality of devices over time.

17. The system of claim 16, wherein the instructions are executable on the processor to:
train the machine learning model based on historical data including the network-observed parameters over time for devices associated with a network, the devices comprising wireless electronic devices and access nodes of the network.

18. The system of claim 16, wherein the instructions are executable on the processor to:
determine an environment parameter representing deployment environments of access nodes in a network that are in a vicinity of the plurality of devices,
wherein the machine learning model produces the information relating to the locations or mobility of the plurality of devices further based on the environment parameter.

19. A method comprising:
providing, in a system comprising a processor, a machine learning model trained based on historical data including network-observed parameters for devices associated with a network;
inputting, in the system, values of the network-observed parameters for a first device into the machine learning model, the values being from a plurality of devices in the network;
producing, by the machine learning model, information relating to a location and mobility including a direction of travel of the first device and a speed of the first device; and
using the information relating to the location or mobility of the first device to control an operation in the network.

20. The method of claim 19, wherein the controlling of the operation in the network comprises any or a combination of troubleshooting an issue in the network, changing a configuration in the network, and controlling roaming of a wireless electronic device in the network.

21. The method of claim 19, wherein the network-observed parameters comprise parameters observed by client devices used for training the machine-learning model.
